(19) United States
(12) Patent Application Publication
(10) Pub. No.: US 2019/0037906 A1
(43) Pub. Date: Feb. 7, 2019

(54) ROASTING ASSEMBLY FOR ROASTING COFFEE BEANS

(71) Applicant: Kai-Cheng Chiu, Minsyong Township (TW)

(72) Inventor: Kai-Cheng Chiu, Minsyong Township (TW)

(21) Appl. No.: 15/669,119

(22) Filed: Aug. 4, 2017

(51) Int. Cl. A23N 12/10; A23F 5/04

(52) U.S. Cl. CPC A23N 12/10; A23F 5/04

(57) ABSTRACT

A roasting assembly for roasting coffee beans includes a housing, a drive shaft, an outer drum, an inner drum, and a heating unit. The drive shaft is rotatably mounted on a front wall of the housing. The outer drum is disposed in the housing and is coupled to be driven by the drive shaft to rotate. The inner drum is disposed in the outer drum and is coupled to be driven to rotate with the outer drum. The heating unit is disposed to heat the outer drum.

### FIELD

The disclosure relates to a roasting assembly, more particularly to a roasting assembly including a drum subassembly.

### BACKGROUND

In a coffee bean roasting process using a conventional device, coffee beans in an accommodation space of a metallic rotary drum are heated using a heater, such as a gas stove. Because the temperature of the metallic rotary drum will rise abruptly in the initial period of roasting, some of the coffee beans in contact with an inner wall of the metallic rotary drum prone to be badly over-roasted, resulting in inferior flavor of the roasted coffee beans.

In addition, if the rotary drum is perforated to permit dried silver skins fell off from the coffee beans to be flung out of the rotary drum, the dried silver skins may fall on the heater, which might cause adverse effect to the roasting process.

### SUMMARY

Therefore, an object of the disclosure is to provide a novel roasting assembly for roasting coffee beans, by which the coffee beans can be evenly heated, and the dried silver skins fell off from the coffee beans will not fall on a heating unit of the roasting assembly.

According to a first aspect of the disclosure, a drum subassembly is used in a roasting assembly for roasting coffee beans. The roasting assembly includes a front wall, a drive shaft, and a heating unit. The drive shaft is mounted rotatably on the front wall about a lengthwise axis, and extends along the lengthwise axis through the front wall to terminate at a driven end forwardly of the front wall, and a drive end segment rearwardly of the front wall. The drum subassembly includes an outer drum and an inner drum. The outer drum is coupled to be driven by the drive end segment to rotate with the drive shaft about the lengthwise axis, and is configured for being radially heated by the heating unit. The outer drum defines therein an inner space. The inner drum is disposed in the inner space and is coupled to rotate with the outer drum about the lengthwise axis. The inner drum defines therein an accommodation space for the coffee beans. The inner and outer drums cooperatively define therebetween a surrounding clearance.

According to a second aspect of the disclosure, a roasting assembly for roasting coffee beans includes a front wall, a drive shaft, a heating unit, and a drum subassembly. The drive shaft is mounted rotatably on the front wall about a lengthwise axis, and extends along the lengthwise axis through the front wall to terminate at a driven end forwardly of the front wall, and a drive end segment rearwardly of the front wall. The drum subassembly includes an outer drum and an inner drum. The outer drum is coupled to be driven by the drive end segment to rotate with the drive shaft about the lengthwise axis, and is configured for being radially heated by the heating unit. The outer drum defines therein an inner space. The inner drum is disposed in the inner space and is coupled to rotate with the outer drum about the lengthwise axis. The inner drum defines therein an accommodation space for the coffee beans. The inner and outer drums cooperatively define therebetween a surrounding clearance.

### BRIEF DESCRIPTION OF THE DRAWINGS

Other features and advantages of the disclosure will become apparent in the following detailed description of the embodiments with reference to the accompanying drawings, in which:

FIG. 1 is a schematic perspective view of a roasting assembly for roasting coffee beans according to a first embodiment of the disclosure;

FIG. 2 is a cross-sectional view of the roasting assembly shown in FIG. 1;

FIG. 3 is a transverse cross-sectional view of the roasting assembly shown in FIG. 1;

FIG. 4 is a schematic perspective view of inner and outer drums of the roasting assembly;

FIG. 5 is similar to FIG. 2 but illustrating a housing of the roasting assembly in a discharging position;

FIG. 6 is similar to FIG. 5 but illustrating a casing of the roasting assembly in a repair position; and

FIG. 7 is a cross-sectional view of a roasting assembly for roasting coffee beans according to a second embodiment of the disclosure.

### DETAILED DESCRIPTION

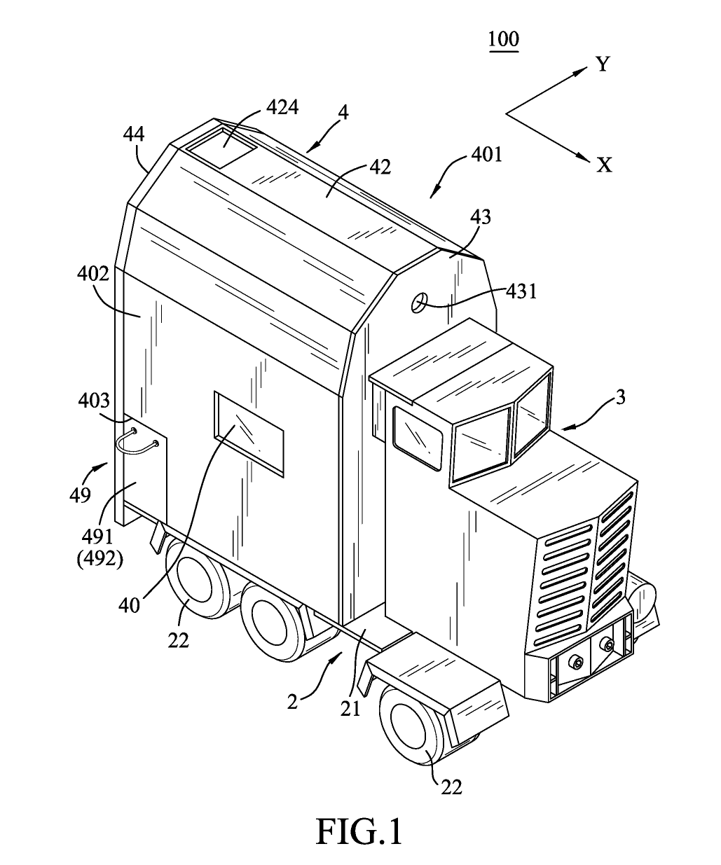

Referring to FIGS. 1 to 3, a roasting assembly 100 for roasting coffee beans 1 according to a first embodiment of the disclosure is shown to include a housing 4, a drive shaft 70, a drum assembly 5, a hopper member 48, and a heating unit 6.

The housing 4 includes a front wall 43, a rear wall 44, and a partition wall 45. The rear wall 44 is spaced apart from the front wall 43 in a direction of a lengthwise axis 50 to define a chamber 400 so as to accommodate the drum subassembly 5. The partition wall 45 partitions the chamber 400 into a heating zone 46 proximate to the front wall 43, and a collecting zone 47 proximate to the rear wall 44. The partition wall 45 has an annular bearing surface 451 surrounding the lengthwise axis 50 and defining a through bore 450.

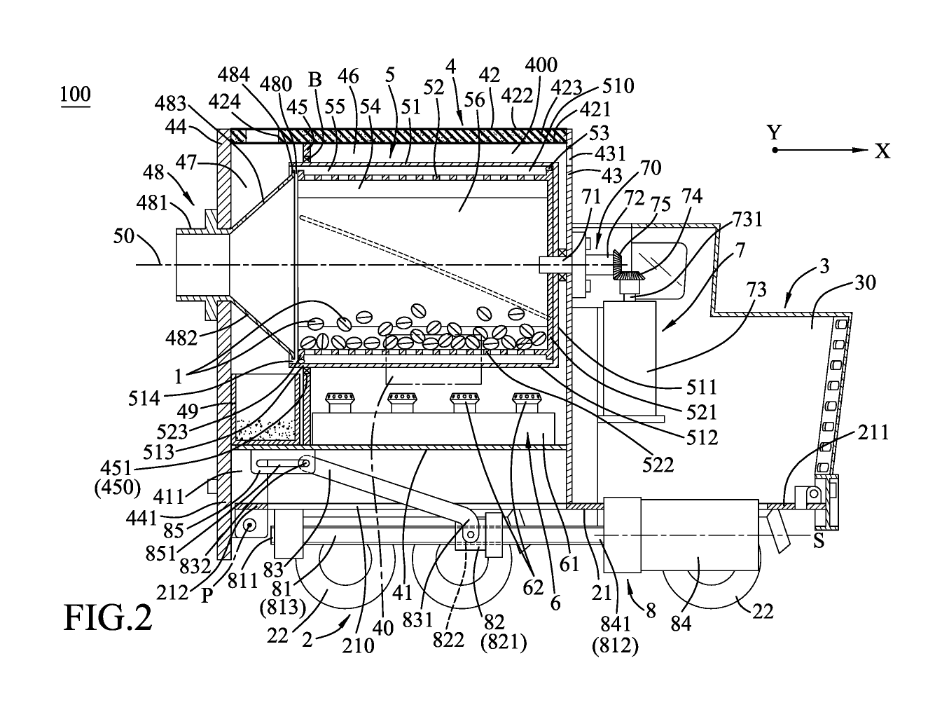

As shown in FIG. 2, the drive shaft 70 is mounted rotatably on the front wall 43 about the lengthwise axis 50, and extends along the lengthwise axis 50 through the front wall 43 to terminate at a driven end 72 forwardly of the front wall 43, and a drive end segment 71 rearwardly of the front wall 43. In this embodiment, the driven end 72 of the drive shaft 70 is disposed outwardly of the housing 4, and the drive end segment 71 is disposed in the heating zone 46.

The drum assembly 5 is disposed in the heating zone 46, and includes an outer drum 51 and an inner drum 52.

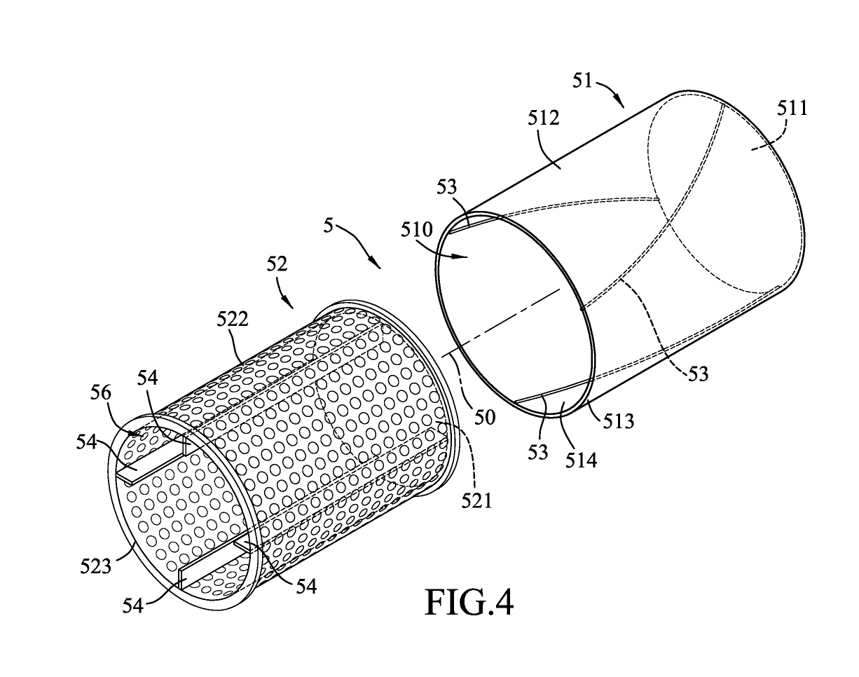

Referring to FIGS. 2 and 4, it can be observed that the outer drum 51 is coupled to be driven by the drive end segment 71 to rotate with the drive shaft 70 about the lengthwise axis 50, and is configured for being radially heated by the heating unit 6. The outer drum 51 defines therein an inner space 510.

In this embodiment, the outer drum 51 includes an outer closed-end wall 511 and an outer cylindrical peripheral wall 512. The outer closed-end wall 511 is secured to the driven end segment 71 to permit the outer drum 51 to rotate with the drive shaft 70 about the lengthwise axis 50. The outer cylindrical peripheral wall 512 extends from a periphery of the outer closed-end wall 511 in the direction of the lengthwise axis 50 to define an inner space 510, and to terminate at an outer open end segment 513 that defines an outlet opening 514. The outer open segment 513 extends through the through bore 450 into the collecting zone 47 so as to permit the inner space 510 to be in spatial communication with the collecting zone 47. The outer open segment 513 is configured to rotate relative to the annular bearing surface 451 of the partition wall 45.

As shown in FIG. 2, the outer open segment 513 is rotate relative to the annular bearing surface 451 of the partition wall 45 with a bearing (B) disposed therebetween.

The inner drum 52 is disposed in the inner space 510 and is coupled to rotate with the outer drum 51 about the lengthwise axis 50. The inner drum 52 defines therein an accommodation space 56 for the coffee beans 1. The inner and outer drums 51, 52 cooperatively define therebetween a surrounding clearance 55. Because the surrounding clearance 55 is provided between the inner and outer drums 51, 52, when the outer drum 51 is rotated by the drive shaft 70 and is heated by the heating unit 6, the coffee beans 1 in the accommodation space 56 of the inner drum 52 are not in contact with the outer drum 51 so as to be evenly heated.

In this embodiment, the inner drum 52 includes an inner closed-end wall 521 and an inner cylindrical peripheral wall 522. The inner closed-end wall 521 is secured to the driven end segment 71 to permit the inner drum 52 to rotate with the outer drum 51. The inner cylindrical peripheral wall 522 extends from a periphery of the inner closed-end wall 521 in the direction of the lengthwise axis 50 to define the accommodation space 56 for the coffee beans 1 and to terminate at an inner open end 523. The inner cylindrical peripheral wall 522 and the outer cylindrical peripheral wall 512 cooperatively define therebetween the surrounding clearance 55 in spatial communication with the collecting zone 47. The inner cylindrical peripheral wall 522 is perforated to permit dried silver skins fell off from the coffee beans 1 to be flung out of the accommodation space 56 into the surrounding clearance 55 for being discharged into the collecting zone 47 through the outlet opening 514. Because the heating zone 46 and the collecting zone 47 are separated by the partition wall 45, the bearing (B), and the outer drum 51, the dried silver skins discharged in the collecting zone 47 are unlikely to disperse to the heating zone 46.

In this embodiment, the drum assembly 5 further includes a plurality of guiding ribs 53 and a plurality of vanes 54.

Each of the guiding ribs 53 is disposed in the surrounding clearance 55 and on one of the outer and inner cylindrical peripheral walls 512, 522. Each of the guiding ribs 53 extends inclined relative to the lengthwise line 50 so as to facilitate the dried silver skins in the surrounding clearance 55 to be discharged to the collecting zone 47. As shown in FIGS. 2 and 4, the guiding ribs 53 are formed on an inner surface of the outer cylindrical peripheral wall 512 to be disposed in the surrounding clearance 55.

The vanes 54 extend in the direction of the lengthwise axis 50, and are secured to an inner surface of the inner cylindrical peripheral wall 522 to be angularly displaced from each other about the lengthwise axis 50 for tumbling the coffee beans 1 during rotation of the drum assembly 5.

The number of the guiding ribs 53 and the vanes 54 can be varied based on design.

The hopper member 48 is disposed rearwardly of the inner drum 52, and includes a neck portion 481 and a funnel portion 482.

The neck portion 481 is secured in the rear wall 44 and extends along the lengthwise axis 50. The funnel portion 482 is disposed in the collecting zone 47, and is flared forwardly from the neck portion 481 to terminate at a surrounding edge 484 which forms a gap 480 with the inner open end 523. The gap 480 is configured to prevent falling-off of the coffee beans 1.

The heating unit 6 is disposed to heat the outer drum 51. In this embodiment, the heating unit 6 is disposed in the heating zone 46 below the outer drum 51, and includes a stove base 61 and a plurality of heating stoves 62 each being a gas stove. Alternatively, the heating unit 6 may include at least one electric heating element.

In this embodiment, the roasting assembly 100 further includes a casing 3 and a first drive unit 7.

The casing 3 is a hollow body, and defines together with the front wall 43 an inner casing space 30 for accommodation of the first drive unit 7.

The first drive unit 7 is disposed outwardly of the housing 4 in the inner casing space 30, and includes a first motor 73 with a first output shaft 731. The first output shaft 731 is configured to couple to the driven end 72 of the drive shaft 70 so as to drive the drive shaft 70 to rotate about the lengthwise axis 50.

As shown in FIG. 2, the roasting assembly 100 further includes a first miter gear 74 and a second miter gear 75. The first miter gear 74 is coupled on an outer end of the first output shaft 731 to rotate with the first output shaft 731. The second miter gear 75 is coupled on the driven end 72 of the drive shaft 70, and is configured to mesh with the first miter gear 74 so as to permit the drive shaft 70 to be driven by the first motor 73 to rotate about the lengthwise axis 50.

In this embodiment, the roasting assembly 100 further includes a base unit 2 includes a mounting base 21 and a plurality of wheels 22.

The mounting base 21 is configured to support the housing 4 and the casing 3, and extends in a longitudinal direction (X) to terminate at a front segment 211 and a rear segment 212. The casing 3 and the housing 4 are disposed on the mounting base 21 and proximate to the front and rear segments 211, 212, respectively.

The wheels 22 may be rotatably mounted to the mounting base 21 to permit movement of the roasting assembly 100. Of course, the wheels 22 may be secured to the mounting base 21 or be optionally omitted.

In this embodiment, the housing 4 further includes a bottom wall 41, an upper wall 42, a left wall 401, a right wall 402, a rear wall extension 441, and amounting plate 411.

The bottom and upper walls 41, 42 are opposite to each other, and the left and right walls 401, 402 are opposite to each other. The bottom, upper, left, and right walls 41, 42, 401, 402 confine the chamber 400 together with the front and rear walls 43, 44.

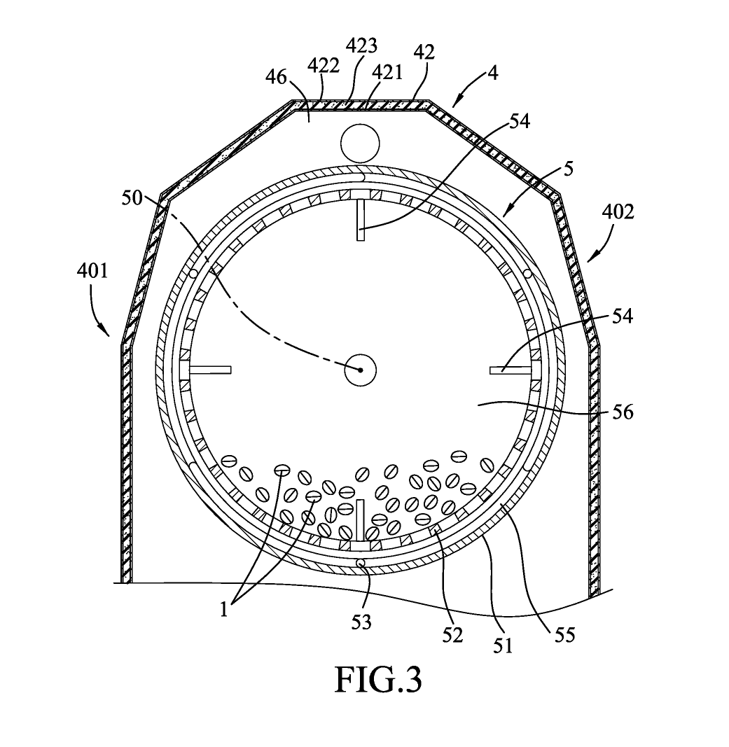

In this embodiment, as shown in FIG. 3, the upper, left, and right walls 42, 401, 402 are integrally formed into one piece which includes an inner layer 421, an outer layer 422, and an thermal insulation layer 423 disposed between the inner and outer layers 421, 422. The thermal insulation layer 423 may be made of a thermal insulation material so as to permit the heater unit 6 to have improved heat efficiency. Alternatively, the thermal insulation layer 423 may be a vacuumed layer sealed between the inner and outer layers 421, 422.

In this embodiment, as shown in FIG. 2, the front wall 43 may have a through hole 431 to permit ventilation of the heating zone 46. The number and configuration of the through hole 431 may be varied based on design. In addition, the bottom wall 41 may be formed with a plurality of through holes (not shown) in spatial communication with the heating zone 46 so as to provide oxygen for the heating stoves 62.

In this embodiment, one of the left and right walls 401, 402 is formed with a viewing window 40 for observation of the frame of the heating stoves 62 in the heating zone 46. As shown in FIG. 1, it is the right wall 402 that is formed with the viewing window 40.

In this embodiment, as shown in FIGS. 1 and 2, one of the left and right walls 401, 402 is formed with an access opening 403 in spatial communication with the collecting zone 47. The roasting assembly 100 further includes a collecting container 49 which is configured to be removably pushed into the collecting zone 47 through the access opening 403 for collecting the dried silver skins, and which has an outer wall 491 with a faceplate 492 configured to be flush with the one of the left and right walls 401, 402 when the collecting container 49 is pushed into the collecting zone 47. As shown in FIG. 1, it is the right wall 402 that is formed with the access opening 403, and the collecting container 49 is disposed on the bottom wall 41 in the collecting zone 47.

In this embodiment, the upper wall 42 has an inlet port 424 in spatial communication with the collecting zone 47, and the funnel portion 482 has a communication port 483 disposed downstream of the inlet port 424 so as to permit the coffee beans 1 poured to the inlet port 424 to fall into the accommodation space 56 through the communication port 483.

The rear wall extension 441 extends downwardly from the rear wall 44. In this embodiment, the rear wall 43, together with the rear wall extension 441 and the hopper member 48, is detachably mounted to rear ends of the bottom, upper, left, and right walls 41, 42, 401, 402.

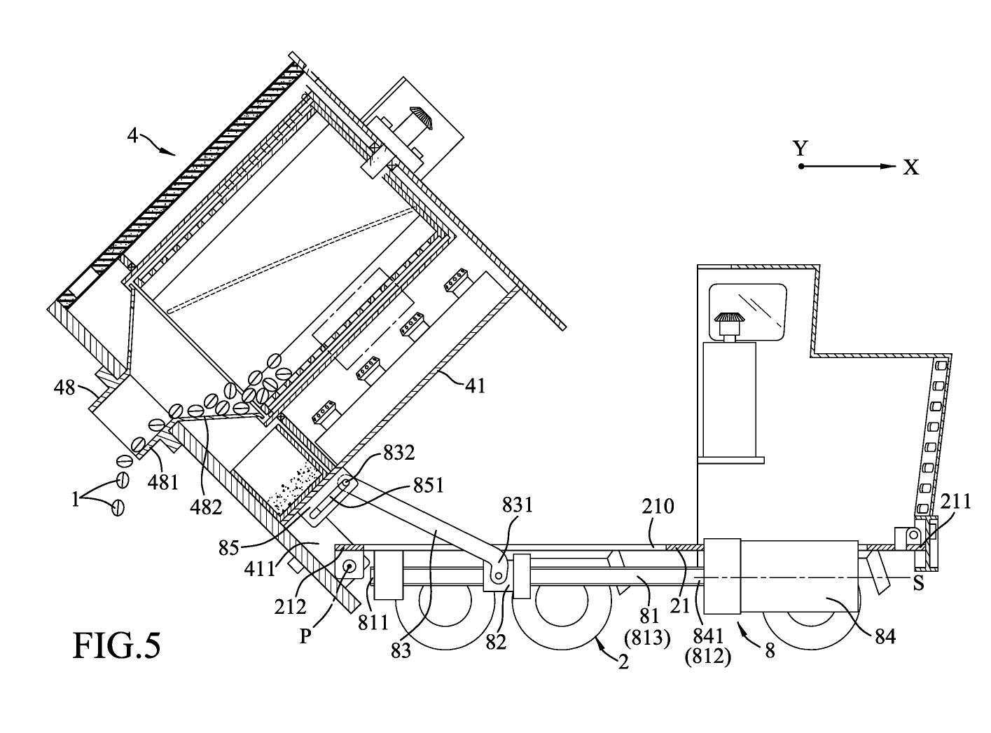

The mounting plate 411 is disposed to extend downwardly from the bottom wall 41 and to connect to the rear wall extension 441, and is pivotally mounted to the rear segment 212 of the mounting base 21 about a pivot axis (P) in a transverse direction (Y) relative to the longitudinal direction (X) to permit the housing 4 to angularly displaceable between a normal position and a discharge position. In the normal position, as shown in FIG. 2, the lengthwise axis 50 is oriented to be parallel to the mounting base 21. In the discharge position, as shown in FIG. 5, the lengthwise axis 50 is oriented at an inclination to the mounting base 21, so as to permit the coffee beans 1 in the accommodation space 56 to be poured out of the housing 4 through the hopper member 48.

In this embodiment, the roasting assembly 100 further includes a lug member 85, a linkage bar 83, a second drive unit 8, a screw shaft 81, and a nut member 82.

The lug member 85 is mounted on a lower surface of the bottom wall 41 and has an engaging slot 851.

The linkage bar 83 extends lengthwise to terminate at a lower end 831 and an upper end 832. The upper end 832 is configured to be loosely engaged in the engaging slot 851.

The second drive unit 8 including a second motor 84 with a second output shaft 841.

The screw shaft 81 extends along a shaft axis (S) in the longitudinal direction (X), and has a rear shaft end 811, a front shaft end 812, and an outer threaded portion 813. The rear shaft end 811 is rotatably suspended below the rear segment 212 of the mounting base 21. The front shaft end 812 is coupled to be driven by the second output shaft 841 to permit the screw shaft 81 to rotate about the shaft axis (S). The outer threaded portion 813 is disposed between the front and rear shaft ends 812, 811. In this embodiment, the front shaft end 812 and the second output shaft 841 are integrally formed.

The nut member 82 has an outer surface 821 and an inner threaded surface 822. The outer surface 821 is coupled to the lower end 831 of the linkage bar 83 to permit the linkage bar 83, together with the housing 4, to move with the nut member 82. The inner threaded surface 822 is configured to be in threaded engagement with the outer threaded portion 813 to translate rotation of the screw shaft 81 into a linear displacement of the nut member 82 between a front position (see FIG. 2), where the housing 4 is in the normal position, and a rear position (see FIG. 5), where the housing 4 is in the discharge position.

In this embodiment, the mounting base 21 is formed with an elongated slot 210 to permit free movement of the linkage bar 83.

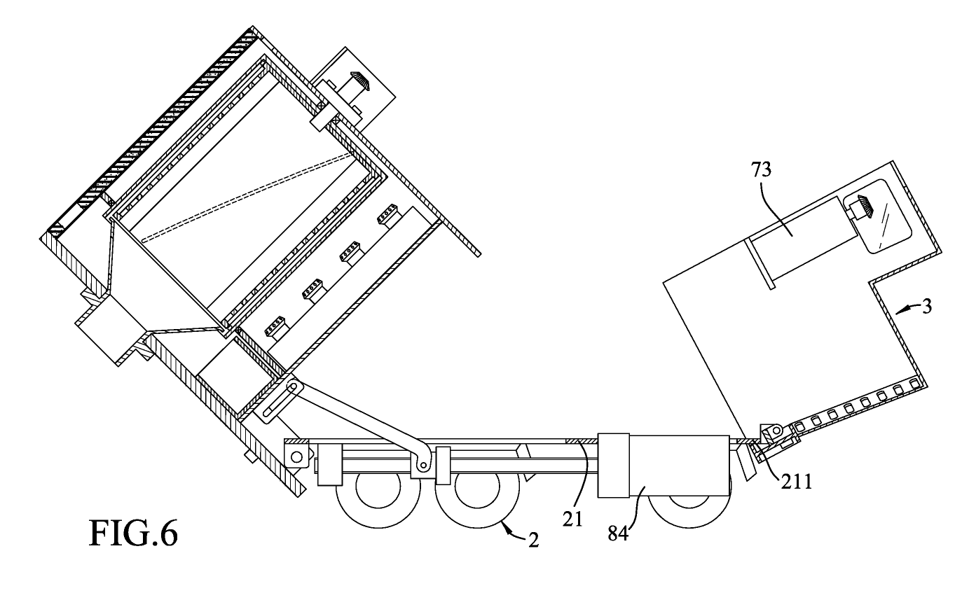

In this embodiment, the casing 3 is pivotally mounted on the front segment 211, and is angularly movable between a closed position and a repair position. As shown in FIGS. 2 and 5, in the closed position, the second motor 84 is covered by the casing 3. As shown in FIG. 6, in the repair position, both the first and second motors 73, 84 are accessible for repair.

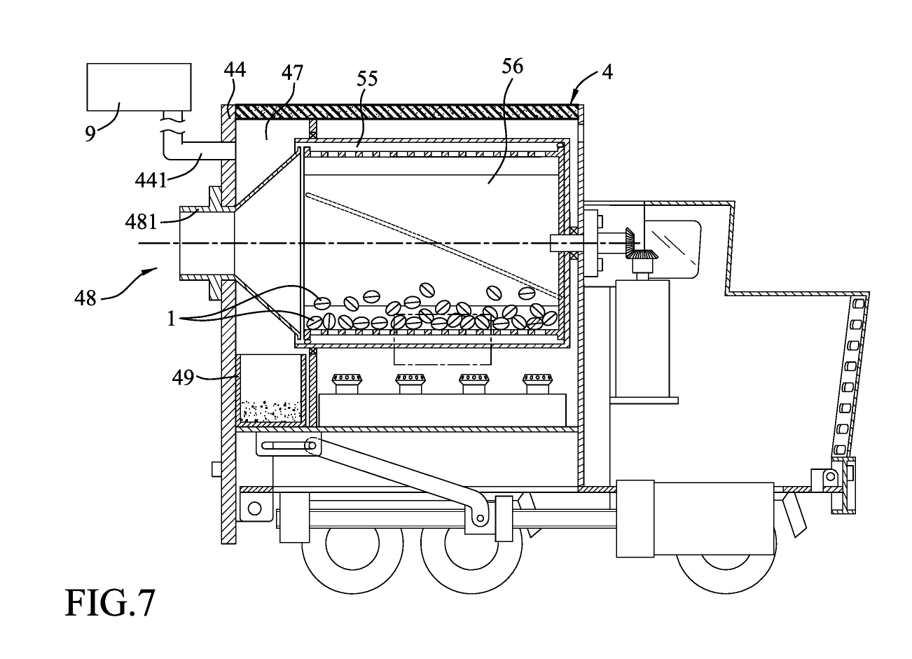

FIG. 7 illustrates a roasting assembly for roasting coffee beans according to a second embodiment of the disclosure. The second embodiment is similar to the first embodiment except that in the second embodiment, the inlet port 424 and the communication port 483 are omitted, and the coffee beans 1 are fed into the accommodation space 56 through the neck portion 481 of the hopper member 48.

In addition, in the second embodiment, the roasting assembly 100 further includes an exhaust fan unit 9 disposed downstream of the collecting zone 47, and configured to exhaust air from the collecting zone 47 so as to facilitate the dried silver skins in the surrounding clearance 55 to be discharged into the collecting zone 47 or be discharged outward through the exhaust fan unit 9. As shown in FIG. 7, the exhaust fan unit 9 is in fluid communication with the collecting zone 47 through a communication pipe 441. The position of the communication pipe 441 can be varied based on requirement.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A drum subassembly used in a roasting assembly for roasting coffee beans, the roasting assembly including
a front wall,
a drive shaft which is mounted rotatably on the front wall about a lengthwise axis, and which extends along the lengthwise axis through the front wall to terminate at a driven end forwardly of the front wall, and a drive end segment rearwardly of the front wall, and
a heating unit,
said drum subassembly comprising:
an outer drum coupled to be driven by the drive end segment to rotate with the drive shaft about the lengthwise axis, and configured for being radially heated by the heating unit, said outer drum defining therein an inner space; and
an inner drum which is disposed in said inner space and which is coupled to rotate with said outer drum about the lengthwise axis, said inner drum being defining therein an accommodation space for the coffee beans, said inner and outer drums cooperatively defining therebetween a surrounding clearance.

2. The drum subassembly according to claim 1, wherein:
said outer drum includes an outer closed-end wall secured to the drive end segment to permit said outer drum to rotate with the drive shaft about the lengthwise axis, and an outer cylindrical peripheral wall which extends from a periphery of said outer closed-end wall in a direction of the lengthwise axis to define said inner space, and to terminate at an outer open end segment that defines an outlet opening; and
said inner drum including an inner closed-end wall secured to the drive end segment to permit said inner drum to rotate with said outer drum, and an inner cylindrical peripheral wall which extends from a periphery of said inner closed-end wall in the direction of the lengthwise axis to define said accommodation space, said inner cylindrical peripheral wall and said outer cylindrical peripheral wall cooperatively defining therebetween said surrounding clearance, said inner cylindrical peripheral wall being perforated to permit dried silver skins fell off from the coffee beans to be flung out of said accommodation space into said surrounding clearance for being discharged from said outlet opening.

3. The drum subassembly according to claim 2, further comprising a plurality of guiding ribs each of which is disposed in said surrounding clearance and on one of said outer and inner cylindrical peripheral walls, and each of which extends inclined relative to the lengthwise line so as to facilitate the dried silver skins in said surrounding clearance to be discharged from said outlet opening.

4. The drum subassembly according to claim 3, further comprising a plurality of vanes which extend in the direction of the lengthwise axis, and which are secured to an inner surface of said inner cylindrical peripheral wall to be angularly displaced from each other about the lengthwise axis.

5. A roasting assembly for roasting coffee beans, comprising:
a front wall;
a drive shaft which is mounted rotatably on said front wall about a lengthwise axis, and which extends along the lengthwise axis through said front wall to terminate at a driven end forwardly of said front wall, and a drive end segment rearwardly of said front wall;
a heating unit; and
a drum subassembly including
an outer drum which is coupled to be driven by said drive end segment to rotate with said drive shaft about the lengthwise axis, and which is configured for being radially heated by said heating unit, said outer drum defining therein an inner space, and
an inner drum which is disposed in said inner space and which is coupled to rotate with said outer drum about the lengthwise axis, said inner drum defining therein an accommodation space for the coffee beans, said inner and outer drums cooperatively defining therebetween a surrounding clearance.

6. The roasting assembly according to claim 5, further comprising a hopper member disposed rearwardly of said inner drum, and a housing including said front wall, a rear wall spaced apart from said front wall in a direction of the lengthwise axis to define a chamber so as to accommodate said drum subassembly, and a partition wall which partitions said chamber into a heating zone proximate to said front wall, and a collecting zone proximate to said rear wall, and which has an annular bearing surface surrounding the lengthwise axis and defining a through bore, wherein:
said driven end of said drive shaft is disposed outwardly of said housing, and said drive end segment is disposed in said heating zone;
said outer drum is disposed in said heating zone, and includes an outer closed-end wall secured to said driven end segment to permit said outer drum to rotate with said drive shaft about the lengthwise axis, and an outer cylindrical peripheral wall extending from a periphery of said outer closed-end wall in the direction of the lengthwise axis to define an inner space, and to terminate at an outer open end segment which extends through said through bore into said collecting zone so as to permit said inner space to be in spatial communication with said collecting zone, and which is configured to rotate relative to said annular bearing surface of said partition wall;
said inner drum includes an inner closed-end wall secured to said driven end segment to permit said inner drum to rotate with said outer drum, and an inner cylindrical peripheral wall which extends from a periphery of said inner closed-end wall in the direction of the lengthwise axis to define said accommodation space for the coffee beans and to terminate at an inner open end, said inner cylindrical peripheral wall and said outer cylindrical peripheral wall cooperatively defining therebetween said surrounding clearance in spatial communication with said collecting zone, said inner cylindrical peripheral wall being perforated to permit dried silver skins fell off from the coffee beans to be flung out of said accommodation space into said surrounding clearance for being discharged into said collecting zone;
said hopper member including
a neck portion which is secured in said rear wall and which extends along the lengthwise axis, and
a funnel portion disposed in said collecting zone, and flared forwardly from said neck portion to terminate at a surrounding edge which forms with said inner open end a gap configured to prevent falling-off of the coffee beans; and
said heating unit is disposed in said heating zone to heat said outer drum.

7. The roasting assembly according to claim 6, wherein said drum subassembly further includes a plurality of guiding ribs each of which is disposed in said surrounding clearance and on one of said outer and inner cylindrical peripheral walls, and each of which extends inclined relative to the lengthwise line so as to facilitate the dried silver skins in said surrounding clearance to be discharged to said collecting zone.

8. The roasting assembly according to claim 6, wherein said drum subassembly further includes a plurality of vanes which extend in the direction of the lengthwise axis, and which are secured to an inner surface of said inner cylindrical peripheral wall to be angularly displaced from each other about the lengthwise axis.

9. The roasting assembly according to claim 6, further comprising a first drive unit which is disposed outwardly of said housing and which has a first output shaft configured to couple to said driven end of said drive shaft so as to drive said drive shaft to rotate about the lengthwise axis.

10. The roasting assembly according to claim 6, further comprising a mounting base extending in a longitudinal direction to terminate at a front segment and a rear segment, said housing further including
a bottom wall confining said chamber,
a rear wall extension extending downwardly from said rear wall, and
a mounting plate which is disposed to extend downwardly from said bottom wall and to connect to said rear wall extension, and which is pivotally mounted to said rear segment of said mounting base about a pivot axis in a transverse direction relative to the longitudinal direction to permit said housing to angularly displaceable between a normal position, where the lengthwise axis is oriented to be parallel to said mounting base, and a discharge position, where the lengthwise axis is oriented at an inclination to said mounting base, so as to permit the coffee beans in said accommodation space to be poured out of said housing through said hopper member.

11. The roasting assembly according to claim 10, further comprising:
a lug member mounted on a lower surface of said bottom wall and having an engaging slot;
a linkage bar extending lengthwise to terminate at a lower end and an upper end which is configured to be loosely engaged in said engaging slot;
a second drive unit including a second output shaft;
a screw shaft extending along a shaft axis in the longitudinal direction, and having
a rear shaft end rotatably suspended below said rear segment of said mounting base,
a front shaft end which is coupled to be driven by said second output shaft to permit said screw shaft to rotate about the shaft axis, and
an outer threaded portion disposed between said front and rear shaft ends; and
a nut member having an outer surface coupled to said lower end of said linkage bar, and an inner threaded surface configured to be in threaded engagement with said outer threaded portion to translate rotation of said screw shaft into a linear displacement of said nut member between a front position, where said housing is in the normal position, and a rear position, where said housing is in the discharge position,
wherein said mounting base is formed with an elongated slot to permit free movement of said linkage bar.

12. The roasting assembly according to claim 10, wherein said housing further includes an upper wall which is opposite to said bottom wall, and which confines said chamber, said upper wall having an inlet port in spatial communication with said collecting zone, said funnel portion having a communication port disposed downstream of said inlet port so as to permit the coffee beans poured to said inlet port to fall into said accommodation space through said communication port.

13. The roasting assembly according to claim 12, wherein said housing further includes a left wall and a right wall which confine said chamber, one of said left and right walls being formed with a viewing window for observation of said heating zone.

14. The roasting assembly according to claim 13, wherein one of said left and right walls is formed with an access opening in spatial communication with said collecting zone, said roasting assembly further comprising a collecting container which is configured to be removably pushed into said collecting zone through said access opening for collecting the dried silver skins, and which has an outer wall with a faceplate configured to be flush with said one of said left and right walls when said collecting container is pushed into said collecting zone.

15. The roasting assembly according to claim 13, wherein said rear wall, together with said rear wall extension and said hopper member, is detachably mounted to rear ends of said bottom, upper, left, and right walls.

16. The roasting assembly according to claim 6, further comprising an exhaust fan unit which is disposed downstream of said collecting zone, and which is configured to exhaust air from the collecting zone so as to facilitate the dried silver skins in said surrounding clearance to be discharged into said collecting zone or be discharged outward through said exhaust fan unit.
